(19) United States
(12) Patent Application Publication
(10) Pub. No.: US 2003/0069804 A1
(43) Pub. Date: Apr. 10, 2003

(54) Systems, apparatus, and methods for verification of telemarketing sales orders

(76) Inventors: Mark Barry, Dedham, MA (US); Ray Blessing, Dedham, MA (US); Paul Thordarson, Dedham, MA (US)

Correspondence Address: Choate, Hall & Stewart, Exchange Place, 53 State Street, Boston, MA, 02109, US

(21) Appl. No.: 10/117,974

(22) Filed: Apr. 8, 2002

Related U.S. Application Data
(60) Provisional application No. 60/282,024, filed on Apr. 6, 2001.

(51) Int. Cl. G06F 17/60

(52) U.S. Cl. 705/26

(57) ABSTRACT

The present invention is a method and system for verification of telemarketing sales orders. According to an embodiment of the method, a sales agent asks a customer a set of questions related to a sales order, including questions required by government regulatory agencies and/or specified by an entity from whom an offer originates. The dialog is recorded by the sales agent's computer, call center server, a stand-alone unit, or a verifier server. After the sale has been established, the customer is presented with the option to review the transaction and accept or reject it. The review dialog, the interaction between the customer and the playback of the recorded offer, and the accept/reject decision are each recorded and archived. In certain embodiments of the invention at least the interaction between the customer and the playback of the recorded offer as well as the accept/reject decision are recorded in a verifier server rather than in the sales agent's computer, call center server, or stand-alone unit.

### CROSS-REFERENCE TO RELATED APPLICATION

This application claims priority to provisional application U.S. S. No. 60/282,024, entitled “Verification of Telemarketing Sales Orders”, filed Apr. 6, 2001, which is herein incorporated by reference.

### BACKGROUND OF THE INVENTION

Telemarketing is increasingly used as a vehicle for direct sales. Corporations are investing significantly in the creation of call centers for both sales and support. In addition, an entire industry has emerged providing outsourced solutions for telemarketing and other call center services.

This increase in telemarketing has also brought with it an increase in fraudulent practices. In the recently deregulated utilities markets (telephone and electricity), the practice of “slamming”—changing a customer's utility provider without the customer's knowledge or permission—became widespread. This forced government, e.g., regulatory agencies such as the Federal Communications Commission (FCC) and Federal Trade Commission (FTC) to promote strict guidelines for what constitutes permission from a customer to switch providers. (See, e.g., Telecommunications Act of 1996). For orders, e.g., change orders, taken via telemarketing, the legal requirement can be met by the use of third party verifiers (TPV). For example, typically after a sales order is taken by phone, the agent taking the order transfers the interested party to an outside and independent agent where the customer is asked to repeat details of the order. The questions used by the third party are either subject to regulatory agency approval (e.g., FCC regulations) or are specified by the company engaging the verifier. Questions and independent verification are designed to insure that the customer agrees with the transaction details and approves the order. In addition, the entire conversation between the customer and the verifier may be recorded and archived, e.g., for up to 36 months off site, for use in resolving potential disputes or aiding in anti-slamming investigations.

This approach has not been without problems. For example, the procedure can be very inconvenient for the consumer. The customer is required to answer a series of questions which, for the most part, duplicates information already provided to the selling agent. In addition, the consumer is usually subjected to hold times while awaiting the availability of a verifier. As staffing is expensive, there may be insufficient operators available during peak periods, resulting in longer hold times and higher customer abandonment. The sales agent may be unable to leave the call until the verifier takes over: this hold time therefore translates into lost sales agent time. Interactive voice response (IVR) systems do exist which can potentially automate the verification dialog. However, the question and answer dialog is complex and taxing for IVR systems: the resulting dialogs are frustrating for the consumer. As a result of these and other drawbacks, orders are often lost in the verification process: 20 to 40 percent of customers drop off while waiting for a live operator: the drop off rate is higher when an IVR system is used. There is a need in the art for improved systems, apparatus, and methods for verification of telemarketing sales orders.

### SUMMARY OF THE INVENTION

The invention provides systems, apparatus, computer-executable process steps, and methods of verifying a telephone transaction. In one aspect, the invention provides a method comprising steps of (a) recording a first recorded transcript of a transaction comprising questions asked by an agent and answers provided by a customer during a telephone call, the questions including those required by a regulatory agency or entity-specified verification questions; (b) playing back the recorded transcript for the customer's review while allowing the customer to control how much of the transcript the customer wishes to review prior to accepting or rejecting the transaction; (c) recording a customer response to accept or reject the transaction and, optionally, recording a second transcript comprising one or more of (i) a playback of a portion of the first recorded transcript and (ii) additional dialog between the customer and the playback of the first recorded transcript; and, optionally, (d) storing either or both of the first transcript and the customer response and, optionally, the second recorded transcript. The method may include a step of electronically conferencing the telephone call between a sales agent, a customer, and a verifier server. Alternately, there may be an open phone connection between the sales agent's phone and the verifier server. In certain embodiments of the method, one or more of the recording steps is performed in a verifier server. The step of playing back is preferably performed by the verifier server. This may further comprise the step of transmitting one or more of the recorded transcripts to a remote data center at which site the transcript(s) may be stored. In certain embodiments of the invention, wireless technology is employed.

According to another aspect, the invention provides apparatus for performing the inventive methods. The apparatus may include a verifier server equipped with one or more phone connections and running applications to communicate with the sales agent's computer and/or phone line and to interact with the customer and manage the recording and playback processes. According to another aspect, the invention provides computer-executable process steps stored on a computer-readable medium to accomplish the methods of the invention.

The contents of all patents, publications, books, articles, etc., mentioned herein are incorporated herein by reference in their entirety. Unless otherwise indicated, definitions of terms related to computers, software, information technology, etc., will be understood to be those found in Microsoft Press Computer User's Dictionary, 4^{th} Ed., Microsoft Press, May 1998 (ISBN: 1572318627).

### BRIEF DESCRIPTION OF THE DRAWING

FIG. 1 illustrates a typical call sequence for a sales order taken over the telephone.

FIG. 2 illustrates a call sequence and verification procedure according to certain embodiments of the invention.

### DETAILED DESCRIPTION OF CERTAIN EMBODIMENTS

The invention provides a new verification method which reduces the frustration and resulting drop off rate of conventional methods while still offering adequate consumer protection against the possibility of slamming. According to certain embodiments of the invention this result is achieved at least in part by eliminating the repetitive sequence of sales related questions followed by verification questions, and/or by providing a customer driven review of the order that is much easier to automate than using IVR technology. The invention thus offers the possibility of greatly reducing or eliminating hold times. In addition, according to certain embodiments of the invention the customer review is optional, allowing users who are comfortable with the order to end the call immediately. The invention further provides systems, apparatus, and computer software (computer-executable process steps, which may be stored on a computer-readable medium such as a floppy disc, hard disc, zip disc, CD-ROM, etc.) to implement the invention.

Although the invention has particular utility for verifying telephone transactions between a sales agent and a potential customer, the invention can be used to verify any type of telephone interaction or transaction between two parties. The invention is particularly useful when it is desired to verify one party's responses, assent, acknowledgment, or agreement. For purposes of simplicity, certain of the embodiments of the invention described herein will refer to sales agent and potential customer, but the invention is not limited to situations in which the parties are sales agent and potential customer or to situations in which the interaction is an offer and acceptance, sale or other commercial transaction. For example, the invention may be used to verify results of a survey, to verify voting (e.g., voting shares in a proxy contest), etc. In general, the term “accept” will be used interchangeable herein with “authorize”, “affirm”, “approve”, etc.

As used herein, the term “sales agent” or “telemarketer” generally refers to an individual who places a phone call to a potential customer and who makes an offer to the potential customer during the course of the phone conversation. Typically the offer will be an opportunity to switch to a different service provider (e.g., a different phone service or other utility service, Internet service provider, etc.). However, the offer can be for sale of a product or of any other sort of service.

As used herein, the term “call center” generally refers to a physical location from which a sales agent places a call to a potential customer. The call center may be owned and/or operated by the entity from whom the offer originates (e.g., a phone company in a case where the offer is an offer to switch to a different phone service), or the call center may be owned and/or operated independently of the entity from whom the offer originates, e.g., by a telemarketing company. For example, the entity from whom the offer originates may employ the call center to perform telemarketing services. The call center may perform telemarketing services for any number of entities. According to certain embodiments of the invention some or all of the participants (e.g., the customer, telemarketing company, call center, entity from whom the offer originates, and third party verifier) are located in different physical locations or legal jurisdictions, e.g., in different building addresses or countries. In the second example, a telemarketer located in a call center in Canada may telephone customers in the United States on behalf of an entity in Mexico. Typically a call center employs multiple sales agents, each of which may have a computer that may interface with a central call center server. However, a call center may have a single telemarketer, e.g., an individual working out of his or her home.

Generally a sales agent follows a script when conducting a conversation with a potential customer. The script is typically predefined, at least in part, though the sales agent may be free to deviate from the script. Typically, while conducting the call, the sales agent is interacting with a computer that runs software to facilitate the telemarketing process. The software may provide an on-screen script and may allow the sales agent to enter details of the order, e.g., customer name, address, credit card information, etc. Some or all of this information may be used later for purposes of fulfilling the order.

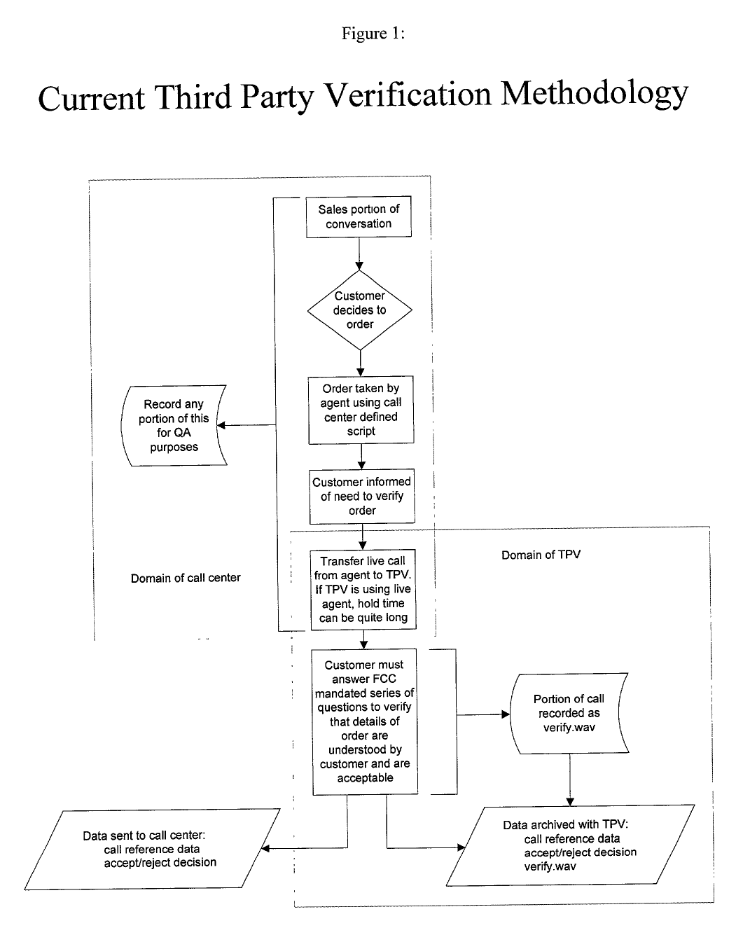

FIG. 1 illustrates a typical call sequence for a sales order taken over the phone. The first steps involve the sales presentation and, if the customer decides to order, collecting any information the selling agent needs to actually process the order. The sales agent may use a script predefined by the call center or the entity from which the offer originates. Once the order is taken to the satisfaction of the selling agent, the customer is informed of the need for verification and the call is transferred to a third party verifier. The third party verifier then asks a set of questions as described above. In some instances (e.g., when verifying a customer's acceptance of an offer to switch phone services), the third party verifier and the verification process must satisfy certain legal requirements. In other instances, the entity from whom the offer originates (or the telemarketing company or call center) may establish its own verification requirements, which may be referred to herein as “entity-specified verification questions” or “entity-established requirements”. Such requirements are typically designed so that the verification process will provide adequate protection (e.g., legal protection) if there is a subsequent dispute regarding whether the transaction occurred or particular details of the transaction. In cases where requirements are mandated by law, these requirements may be supplemented as desired by the entity from whom the offer originates, the telemarketing company, and/or the call center. Generally, the third party verifier must be independent. The meaning of the term “independent” may vary depending upon the particular requirements, e.g., legal requirements. Typically, an independent third party verifier is controlled, owned and operated separately from either the telemarketing company, call center, or the entity from which the offer originates.

The invention provides software (i.e., one or more application programs) to implement the improved third party verification method. The software may be written in any appropriate programming language, e.g., Java, C^{++,} XML, etc. The software may be provided in any of a variety of ways. According to certain embodiments of the invention certain components of the application run on a call center computer, e.g., on the sales agent's computer or on a server (computer) at the call center location. The software may be provided on a computer-readable medium such as a floppy disc, hard disc, zip disc, CD-ROM, etc., or may be transferred electronically to the call center. The software of the invention may be integrated into the telemarketing software used by the sales agent. Alternately, these components of the software may run on a server controlled by the third party verifier, which may be located at a site remote from the call center. According to these embodiments of the invention the third party verifier acts as an application service provider (ASP), and the sales agents interact remotely with the software, e.g., over the Internet, VPN, local telephone lines, wireless, etc. One of ordinary skill in the art will appreciate that the invention may be implemented in any of a wide variety of configurations.

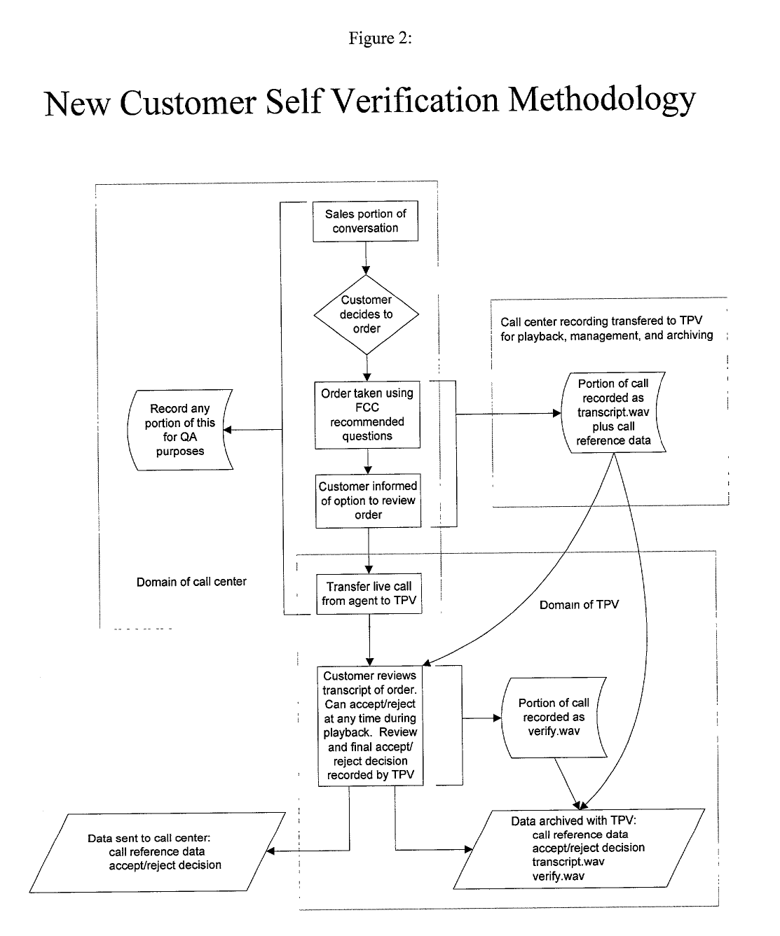

FIG. 2 illustrates a call sequence and verification procedure according to certain embodiments of the invention. The first steps involve the sales presentation and, if the customer decides to order, collecting any information the selling agent needs to actually process the order (such as confirming the identity of the party on the line, etc). The customer may be informed that part or all of the conversation will be recorded. The sales agent may use a script predefined by the telemarketing company, call center, or the entity from which the offer originates. However, according to the invention the sales agent takes the order with a single set of questions which will include the questions required by the regulatory agencies, the entity employing the telemarketing company, the telemarketing company, or the call center itself. At the end of the set of questions (which may include sales-related and verification questions), the customer is informed that a final approval step is required.

The invention allows third party verification to occur through a self-verification process in which the customer may review all or part of the conversation and indicate his or her acceptance or rejection of the offer. According to the invention, part or all of (i) the question and answer dialog, (ii) the offer that was made, and (iii) a statement that a final approval step is needed are recorded. The recording is represented by transcript.wav in FIG. 2. The recording will be referred to herein as a transcript. According to preferred embodiments of the invention the transcript includes all questions required by the relevant regulatory agency or the entity engaging the telemarketer as well as the customer's answers thereto. In preferred embodiments of the invention the transcript is recorded in either the third party verifier's server (on or off site) or in the sales agent's computer or call center server via a telephony-computer interface as a digital audio file. To facilitate such recording the sales agent's computer or call center server typically includes a computer telephone interface card (CTI card), available, e.g., from Dialogic® (now owned by Intel Corporation, 2200 Mission College Blvd., Santa Clara, Calif. 95052-8119) and appropriate interface software, e.g., TAPI (Telephony Application Program Interface), such as are well known in the art, to interface with the sales agent's telephone. The software of the invention manages the digital recording process, e.g., using RealNetworks for digital recording, and (in a case where the transcript is recorded in the sales agent's computer, call center computer, or in a stand-alone digital recording unit as shown in FIG. 2) subsequent transfer of the digital audio file after the order is completed to a server (referred to herein as a “verifier server”) controlled by the independent third party verifier. The verifier server is also equipped with a CTI card and phone line connection(s). The verifier server may be equipped with multiple phone lines in order to handle multiple transactions simultaneously.

The recording process may be initiated in any of a variety of ways according to different embodiments of the invention. For example, the recording process may be initiated by the sales agent, e.g., the sales agent may depress a specified key on the computer keyboard (e.g., the F5 key). According to yet another embodiment of the invention, the recording process may be initiated manually by the sales agent through use of a stand-alone digital recording unit integrated with the third party verifier's server. Alternately, the invention may include voice recognition software, such as is well known in the art. The voice recognition software may recognize a predefined word or phrase that the sales agent speaks. For example, the script spoken by the sales agent may contain a sentence such as, “Now I will need to get some additional information . . . ” This trigger may also initiate a telephone connection between the two parties and the verifier server.

After the appropriate portions of the conversation (including the questions mandated by law (or by the entity from whom the offer originates) for verification purposes and the answers thereto), the sales agent notifies the customer that he/she is dropping off the line and that the offer will be played back for the customer's review and verification. According to certain embodiments of the invention the sales agent is notified that the customer is about to receive the transcript for review and the conference call is now only two lines, the customer and the verifier. In certain embodiments of the invention the verifier server is conferenced in to the phone call between the sales agent and customer at an appropriate point in the conversation as described above, while in other embodiments of the invention the verifier server maintains an open phone connection with the sales agent's telephone and may initiate the recording process at an appropriate time. In either case, the actual recording of the conversation may take place in the sales agent's computer, central call center server, stand-alone unit, or verifier server.

As with initiation of the recording process, the initiation of self-verification may be accomplished in any of a variety of ways according to different embodiments of the invention. For example, it may be initiated manually by the sales agent (e.g., by depressing a key on the keyboard, by activating a stand-alone unit, etc.) or by voice recognition software, which may initiate the file transfer when the sales agent says, for example, “Now I'm going to play back this transaction for your final approval.” In certain embodiments of the invention the playback is performed by the verifier server. However, in other embodiments of the invention the playback may occur from the sales agent's computer or call center server. Any of these computers may be equipped with a standard (e.g., factory installed) audio card to perform the playback.

The third party verifier server may be located at the call center site or remotely, e.g., at the third party verifier location, or there may be servers at both sites. In preferred embodiments of the invention the third party verifier server is secure, and transmission and storage of information (e.g., of digital audio files) are conducted according to secure procedures and standards such as are well known in the art. In general, the following seven areas may be addressed by the security features of the invention: (1) Confidentiality (2) Authentication (3) Integrity (4) Nonrepudiation (5) Access control: (6) Availability and (7) Storage. Computer and network security issues and approaches are discussed in Stallings, W., Cryptography and Network Security: Principles and Practice, Second Edition, Prentice-Hall, Upper Saddle River, 1999. Further information on specific aspects of computer security may be found in Maximum Security: A Hacker's Guide to Protecting Your Internet Site and Network, Second Edition, Macmillan, Inc., Indianapolis, 1998.

Prior to playback of the recorded transcript, the customer is offered the option to accept or reject the order. The customer is informed that he/she can exercise either option immediately, ending the call without further inconvenience, or review all or just part of the recorded transcript. The customer may interact with the third party verifier by using the touch-tone buttons on his or her phone. Alternately, voice recognition may be used, allowing the customer to respond by speaking. If the customer chooses the review option, the transcript is played back. During the playback, the customer may accept or reject the order at any time without listening to the entire recording. Appropriate instructions are given to the customer to allow him or her to effectively interact with the verifier server.

In preferred embodiments of the invention some or all of the self-verification dialog is recorded in the verifier server as a digital audio file. In preferred embodiments of the invention the entire verification procedure is recorded in the verifier server. This recording is represented as verify.wav in FIG. 2. While recording the verification dialog and customer acceptance or rejection in the verifier server is generally preferred and may be legally mandated, in certain embodiments of the invention the playback and recording of the verification dialog and customer acceptance or rejection of the order are performed in the sales agent's computer or call center computer. The recording of the verification dialog may then be extracted from or uploaded by the verifier server and stored with the verifier.

According to certain embodiments of the invention, if the customer does not provide a definitive acceptance or rejection of the offer (e.g., if the customer hits an incorrect button on his phone or if the customer's response cannot be understood by the voice recognition system), or if the customer does not satisfactorily answer any required verification questions, the system may repeat all or part of the verification dialog. The system may also provide an option to transfer the call back to a live operator, e.g., a sales agent at the call center. The third party verifier server can conference in the sales operator or the call center in a similar fashion to the way the phone call was transferred to the third party verifier server.

In preferred embodiments of the invention the transcript file (containing at least a portion of the conversation between the sales agent and the customer including any legally mandated and/or entity-specified verification questions) and the verify file (containing the review dialog and the final customer decision (accept or reject), are managed and archived by the third party verifier for the mandated period of time (e.g., 24 months for current FCC regulations, 36 months for the FTC, or periods specified by the client who engages in the third party verification service).

According to certain embodiments of the invention these files may be combined into a single file (or, if desired, divided into multiple files). In those embodiments of the invention in which the customer is transferred to a verifier server at the call center site, this server may temporarily store the files prior to transferring them to a data center server located at the third party verifier site or elsewhere. Transfer may be in real time or be metered to conserve bandwidth requirements, e.g., to make use of time slots during which use of phone lines, etc., is low. Transfer may take place using any appropriate transmission lines, e.g., dedicated transmission lines (e.g., VPN), phone lines, Internet, cables. In certain embodiments of the invention the verifier server notifies some or all of (i) the call center or telemarketing company; (ii) the entity from whom the offer originates; (iii) an offer fulfillment center; (iv) a specified contact address, of the customer's accept or reject decision. Such notification may occur according to any appropriate technique, e.g., e-mail, file transfer (e.g., FTP), etc. Thus in general, the invention includes hardware and/or code (computer-executable process steps) to accomplish some or all of the following:

(1) Detect a signal from a sales agent (e.g., depression of a particular key on the sales agent's keyboard; activation of a stand-alone unit; voice recognition software, etc.)

(2) Initiate a telephone line connection “conference call” between the verifier server and two parties on the phone

(3) Record all or part of the conversation between the agent and the customer

(4) Notify the agent and customer that the playback is about to begin

(5) Play back the recorded transaction to the customer

These tasks may be accomplished by the sales agent's computer, call center server, or verifier server and may be divided between them. In general, the verifier server includes hardware and/or software to accomplish the following tasks (although in certain embodiments of the invention some of these tasks may be performed by the sales agent's computer or call center server as described above):

(1) Extract and/or receive a digital audio file containing a recording of a conversation between the sales agent and the customer (in the case where the conversation is recorded in the sales agent's computer, call center computer, or a stand-alone unit)

(2) Receive a digital response that the agent is off the phone

(3) Play back all or part of a digital audio file including question answer dialog, with playback length controlled by the customer

(4) Receive customer response(s) (which may require IVR and ASR technology)

(5) Create file (verify file) of recorded customer response(s) and, optionally, create date/time stamp and/or compute digest value and append to file

(6) Transmit the digital audio file to a data center or third party verifier server at a remote location

(7) Notify call center, fulfillment center, or specified contact address of customer's accept or reject decision

As will be evident from the foregoing description, these tasks are not necessarily performed in the order listed above, and the listing is not intended to imply that one task must be completed before another. For example, during the playback the verifier server may intermittently be receiving and recording customer responses. In general, in preferred embodiments of the invention the verifier server (rather than the sales agent's computer or call center server or stand-alone unit) records the verification dialog (i.e., the playback of part or all of the conversation between the sales agent and customer as well as the customer's responses during the playback, including the customer's acceptance or rejection of the offer).

The methods of the invention provide a number of advantages. First, repetition of the order information is eliminated: a single set of questions is asked by the sales agent. The verification dialog is very simple: an IVR solution using touch tone input or automatic speech recognition (ASR) is relatively easy to implement according to standard technique, greatly reducing or eliminating the “hold for operator” delays. The review of the dialog is optional, thus allowing the customer to authorize and/or end the call at any time. Finally, because the single set of questions still includes the information required by regulations, and because the recordings are managed and archived by a third party, this approach offers protection against slamming and other fraudulent practices.

According to certain embodiments of the invention the transcript and/or verify files include a date and/or time stamp. The date and/or time stamp provides additional authentication that the order took place. The transcript may include a digest value, which may be determined based on all or part of the transcript. Methods for producing a digest are well known in the art. They may involve, e.g., applying a hash function to all or part of the message. See, e.g., Stallings, W., referenced above. A digest value provides authentication that the transcript has not been altered. The date/time stamp and/or digest value may be appended to the transcript and/or verify files. According to certain embodiments of the invention the file(s) may be converted into an alternative format. The files may be compressed and/or encrypted.

As will be evident to one of ordinary skill in the art, a number of variations are within the scope of the invention. For example, as government regulations change, the particular questions asked can be changed accordingly. The time for which transcripts are stored can also be changed and the exact content to be stored can vary, e.g., it may not be necessary to record and store all parts of the interaction between customer and sales agent or between customer and third party verifier. In addition, the third party verification and storage functions need not be performed by the same party, provided that both functions are performed in a way that meets the legal standards mandated for independence.

The invention is not limited to a particular predefined script. The sales agent may use any appropriate script, may supplement a predefined script with additional conversation, or may compose a script “on the fly” during the conversation. Different questions may be appropriate for different sales and order scenarios. For example, while the invention may be particularly useful in the context of orders that involve a customer switching to a different service such as a phone service, Internet service provider, utility, etc., the invention can be used for verifying any type of order.

Although the invention has been described in terms of interactions between a single sales agent, sales agent's computer and telephone, potential customer, and verifier's server, it is to be understood that the system will typically handle multiple sales agents and phone calls concurrently.

One of ordinary skill in the art will readily be able to adapt and configure the system appropriately to implement such variations and others. Thus the invention is not to be taken as limited to the particular embodiment described herein.

We claim:

1. A method of verifying a telephone transaction comprising steps of:
recording a first recorded transcript of a transaction comprising questions asked by an agent and answers provided by a customer during a telephone call, the questions including those required by a regulatory agency or entity-specified verification questions;
playing back the recorded transcript for the customer's review while allowing the customer to control how much of the transcript the customer wishes to review prior to accepting or rejecting the transaction;
recording a customer response to accept or reject the transaction and, optionally, recording a second transcript comprising one or more of (i) a playback of a portion of the first recorded transcript and (ii) additional dialog between the customer and the playback of the first recorded transcript; and
storing either or both of the first transcript and the customer response and, optionally, the second recorded transcript.

2. The method of claim 1 further comprising the step of:
electronically conferencing the telephone call between a sales agent, a customer, and a verifier server.

3. The method of claim 1, wherein one or more of the recording steps is performed in a verifier server.

4. The method of claim 1, wherein the second recording step and, optionally, the optional recording step, are performed in a verifier server.

5. The method of claim 1, wherein the step of playing back is performed by a verifier server or verifier software resident in the agent or call center's server.

6. The method of claim 1, wherein the agent or call center and the customer are physically located in different legal jurisdictions.

7. The method of claim 1, further comprising the step of:
notifying a call center, fulfillment center, or specified contact address of the customer's accept or reject decision.

8. The method of claim 1, wherein the transaction includes an offer to switch service providers.

9. The method of claim 1, wherein the transaction includes an offer to purchase a product.

10. The method of claim 1, further comprising the step of transmitting one or more of the recorded transcripts to a remote data center, and wherein the storing step comprises storing at a remote data center.

11. A method of fulfilling an order comprising the step of:
receiving a verified order, wherein the order is verified according to the method of claim 1.

12. An apparatus for verifying a telephone transaction comprising steps of:
one or more memories which store computer-executable process steps;
one or more processors that execute the process steps so as to
(i) record a first recorded transcript of a transaction comprising questions asked by an agent and answers provided by a customer during a telephone call, the questions including those required by a regulatory agency or entity-specified verification questions;
(ii) play back the recorded transcript for the customer's review while allowing the customer to control how much of the transcript the customer wishes to review prior to accepting or rejecting the transaction; and
(iii) record a customer response to accept or reject the transaction and, optionally, recording a second transcript comprising one or more of (i) a playback of a portion of the first recorded transcript and (ii) additional dialog between the customer and the playback of the first recorded transcript.

13. The apparatus of claim 12, wherein one or more of the processors executes process steps to store, either locally or remotely, either or both of the first transcript and the customer response and, optionally, the second recorded transcript.

14. Computer-executable process steps stored on a computer-readable medium, the computer-readable process steps comprising:
(i) code to record a first recorded transcript of a transaction comprising questions asked by an agent and answers provided by a customer during a telephone call, the questions including those required by a regulatory agency or entity-specified verification questions;
(ii) code to play back the recorded transcript for the customer's review while allowing the customer to control how much of the transcript the customer wishes to review prior to accepting or rejecting the transaction; and
(iii) code to record a customer response to accept or reject the transaction and, optionally, recording a second transcript comprising one or more of (i) a playback of a portion of the first recorded transcript and (ii) additional dialog between the customer and the playback of the first recorded transcript.

15. Computer-executable process steps according to claim 14, further comprising:
(iv) code to store, either locally, or remotely, either or both of the first transcript and the customer response and, optionally, the second recorded transcript.

16. The method of claim 1, wherein one or more of the recording steps or the playback step is initiated manually by the agent.

17. The method of claim 1, wherein one or more of the recording step or the playback step is initiated automatically upon recognition of a word or phrase spoken by the agent.

18. The method of claim 1, wherein the customer interacts with the verifier server using an interactive voice response system.
